(19) United States
(12) Patent Application Publication
(10) Pub. No.: US 2025/0337180 A1
(43) Pub. Date: Oct. 30, 2025

(54) ELECTRICAL CONNECTOR ASSEMBLY WITH ELECTRICAL CONNECTOR

(71) Applicant: LOTES CO., LTD, Keelung (TW)

(72) Inventors: Yu-Lun Tsai, Keelung (TW); Quan-Kun Li, Keelung (TW); Xian-Lai Xu, Keelung (TW)

(21) Appl. No.: 19/021,751

(22) Filed: Jan. 15, 2025

(30) Foreign Application Priority Data
Apr. 26, 2024 (CN) 202420903227.6

(51) Int. Cl. H01R 12/72; H01R 12/70

(52) U.S. Cl. CPC H01R 12/721; H01R 12/707

(57) ABSTRACT

An electrical connector, which is used to mate with a mating component. The electrical connector includes an insulating body, concavely provided with an insertion slot. A plurality of terminal slots are arranged along the longitudinal direction. Each terminal has a fixing portion. Two contact arms extend upward from the neck portion. The two contact arms protrude toward each other to form two contact portions protruding into the insertion slot. Along the longitudinal direction, the first protruding portion and the second protruding portions respectively interfere with two opposite inner walls of the corresponding terminal slots, such that the two contact portions of each terminal may stably clamp the mating component, and the terminal is inserted and centered into the corresponding terminal slot.

### CROSS-REFERENCE TO RELATED PATENT APPLICATION

This non-provisional application claims priority to and the benefit of, pursuant to 35 U.S.C. § 119(a), patent application Serial No. CN202420903227.6, filed in China on Apr. 26, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector assembly with an electrical connector, and particularly to an electrical connector assembly with an electrical connector that prevents the terminals from mounting deviations.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing power connector, such as the power connector disclosed in the Chinese Patent No. CN202011261236.2, is used to mate with a first substrate. The power connector includes a shell. The shell is concavely provided with a slot, and the slot is longitudinally provided in a longitudinal direction. The shell is further provided with a plurality of power contact slots. A plurality of power contacts are respectively retained in the power contact slots, and the power contacts are all in flat plate shapes. Each power contact has a contact body, and two matching ends extend upward from the contact body. The two matching ends respectively protrude from two sides of the slot in a lateral direction into the slot to abut against the first substrate. A barb is protrudingly provided at each of two sides of the contact body in the lateral direction. When each power contact is mounted in a corresponding power contact slot, the barbs interfere with the inner walls of the power contact slot, such that the power contact may be stably fixed in the shell to be mated with the first substrate.

However, since the contact body is fixed to and interferes with the corresponding power contact slot laterally through the barbs, a gap exists between the contact body and the power contact slot in the longitudinal direction, such that the contact body is prone to oblique insertion during the mounting, thus affecting the mating between the matching ends and the first substrate. In addition, since the contact body is fixed laterally in the corresponding power contact slot, the two matching ends extend upward from an upper end of the contact body, and the two matching ends respectively abut against two surfaces of the first substrate along the lateral direction, when the first substrate is obliquely inserted into the slot, one of the matching ends of the power contact is subjected to a force and pushed to deviate laterally toward a side away from the center of the slot, and the other matching end of the power contact does not swing following the deviation of the one of the matching ends, thus resulting in a gap between the other matching end, which is not abutted by the first substrate, and the first substrate, preventing the two from being conductive with each other, and thereby affecting the signal transmission between the first substrate and the electrical connector.

Therefore, a heretofore unaddressed need to design a new electrical connector assembly with an electrical connector exists in the art to address the aforementioned deficiencies and inadequacies.

### SUMMARY

The present invention is directed to an electrical connector assembly with an electrical connector, in which gaps exist between the neck portion and inner wall surfaces of a corresponding terminal slot in the longitudinal direction and the lateral direction, and along the longitudinal direction, the fixing portion is provided with a first protruding portion and two second protruding portions with different protruding directions to interfere with the two side walls of the corresponding terminal slot, such that even though the mating component is obliquely inserted into the insertion slot of the insulating body, the two contact portions of the terminal may stably clamp the two surfaces of the mating component, allowing the terminal to be inserted and centered in the corresponding terminal slot.

To achieve the foregoing objective, the present invention adopts the following technical solutions:

An electrical connector is configured to mate with a mating component. The electrical connector includes: an insulating body, concavely provided with an insertion slot downward from top thereof, wherein the insertion slot extends along a longitudinal direction, a plurality of terminal slots are arranged along the longitudinal direction, and each of the terminal slots is in communication with two opposite sides of the insertion slot along a lateral direction; and a plurality of terminals, respectively retained in the terminal slots, each of the terminals has a fixing portion, a neck portion extends upward from the fixing portion, gaps exist between the neck portion and inner wall surfaces of a corresponding one of the terminal slots in the longitudinal direction and the lateral direction, two contact arms extend upward from the neck portion, the two contact arms protrude toward each other to form two contact portions protruding into the insertion slot, the fixing portion is protrudingly provided with at least one first protruding portion and at least two second protruding portions with protruding directions opposite to a protruding direction of the first protruding portion, the first protruding portion is at least partially located right below the neck portion, the two second protruding portions are respectively located adjacent to two opposite side edges of the fixing portion in the lateral direction, and along the longitudinal direction, the first protruding portion and the second protruding portions respectively interfere with two opposite inner walls of the corresponding one of the terminal slots; wherein when the mating component is inserted downward into the insertion slot to be mated with the terminals, the two contact portions of each of the terminals respectively clamp the mating component along the lateral direction.

In certain embodiments, the fixing portion has a positioning plate and two retaining arms extending upward from the positioning plate, the two retaining arms are respectively located at two opposite sides of the neck portion along the lateral direction, the first protruding portion is formed by protruding from the positioning plate in a thickness direction thereof, each of the two retaining arms is protrudingly provided with one of the second protruding portions along a respective thickness direction, each of the second protruding portions extends downward to the positioning plate, and a dimension of the first protruding portion extending along the lateral direction is greater than a dimension of each of the second protruding portions extending along the lateral direction.

In certain embodiments, a side edge of each of the retaining arms away from the neck portion along the lateral direction is laterally protrudingly provided with two protruding barbs at an interval along an up-down direction, each of the retaining arms is protrudingly provided with a protruding bump between the two protruding barbs, a protruding direction of the protruding bump is identical to the protruding direction of the first protruding portion, the protruding bump and the first protruding portion collectively interfere with the inner wall of the corresponding one of the terminal slots along the thickness direction of the positioning plate, and the protruding barbs of the two retaining arms interfere with the two inner walls of the corresponding one of the terminal slots along the lateral direction.

In certain embodiments, the positioning plate has two soldering legs extending downward, two soldering legs of two adjacent ones of the terminals are provided to be staggered to each other, for a same one of the terminals, a distance between one of the two soldering legs and a central line of the neck portion and a distance between the other of the two soldering legs and the central line of the neck portion are not equal to each other, a strip connecting portion is protrudingly provided on a lower end of the positioning plate, the strip connecting portion is located between the two soldering legs, and the central line of the neck portion passes downward through the strip connecting portion.

In certain embodiments, a distance between each of the contact portions and an inner side wall of the insertion slot located at a same side of the insertion slot is greater than 0.2 mm, a side of each of the contact portions adjacent to the center of the insertion slot has an oblique surface, the oblique surface extends obliquely toward the center of the insertion slot downward from top thereof, and an included angle between the oblique surfaces of the two contact portions of each of the terminals is less than 30°.

Further, an electrical connector assembly includes an electrical connector and a mating component mated with each other. In the electrical connector, the terminals comprise a positive terminal group formed by a plurality of positive terminals arranged at consecutive intervals and a negative terminal group formed by a plurality of negative terminals arranged at consecutive intervals, the positive terminal group and the negative terminal group are provided to be arranged adjacent to each other in the longitudinal direction, each of two surfaces of the mating component along the lateral direction is provided with at least one first contact pad and at least one second contact pad adjacent to each other along the longitudinal direction, the first contact pad and the positive terminal group mate with each other, and the second contact pad and the negative terminal group mate with each other.

In certain embodiments, a lower end of a side of the first contact pad adjacent to the second contact pad is provided with a first chamfer, a lower end of a side of the second contact pad adjacent to the first contact pad is provided with a second chamfer, and the first chamfer and the second chamfer are provided opposite to each other along the longitudinal direction.

In certain embodiments, the positive terminal group comprises at least 10 of the positive terminals, the negative terminal group comprises at least 10 of the negative terminals, a distance between the positive terminal group and the negative terminal group along the longitudinal direction is greater than a distance between any two adjacent ones of the positive terminals and a distance between any two adjacent ones of the negative terminals, two first contact pads and two second contact pads are located on the same surface of the mating component and are provided at intervals along the longitudinal direction, the two first contact pads are provided to be adjacent to each other and mate with the positive terminal group, and the two second contact pads are provided to be adjacent to each other and mate with the negative terminal group.

In certain embodiments, the terminals are blanking terminals in flat plate shapes, a plate surface of each of the terminals is perpendicular to the longitudinal direction, and cutting surfaces of the two contact portions of each of the terminals are mated with the first contact pads or the second contact pads of two surfaces of the mating component in a thickness direction thereof.

In certain embodiments, along the lateral direction, the insertion slot has a first dimension, the mating component has a second dimension, the first dimension is greater than the second dimension, and a difference between the first dimension and the second dimension is greater than or equal to 0.4 mm.

Further, an electrical connector assembly includes: an electrical connector, having an insulating body, wherein the insulating body is concavely provided with an insertion slot downward from top thereof, the insertion slot extends along a longitudinal direction, a plurality of terminals are provided in the insertion slot at intervals along the longitudinal direction, each of the terminals has a fixing portion, a neck portion extends upward from the fixing portion and is capable of swinging along a lateral direction, two contact arms extend upward from the neck portion, the two contact arms protrude toward each other to form two contact portions protruding into the insertion slot, along the longitudinal direction, the fixing portion is protrudingly provided with at least one first protruding portion and at least two second protruding portions with protruding directions opposite to a protruding direction of the first protruding portion, the first protruding portion is at least partially located right below the neck portion, the two second protruding portions are respectively located adjacent to two opposite side edges of the fixing portion in the lateral direction, the terminals comprise a positive terminal group formed by a plurality of positive terminals arranged consecutively and a negative terminal group formed by a plurality of negative terminals arranged consecutively, and the positive terminal group and the negative terminal group are provided to be arranged adjacent to each other in the longitudinal direction; and a mating component inserted into the insertion slot downward from top thereof, wherein each of two surfaces of the mating component in the lateral direction is provided with at least one first contact pad and at least one second contact pad adjacent to each other along the longitudinal direction, the first contact pad and the positive terminal group mate with each other, a lower end of a side of the first contact pad adjacent to the second contact pad is provided with a first chamfer, the second contact pad and the negative terminal group mate with each other, a lower end of a side of the second contact pad adjacent to the first contact pad is provided with a second chamfer, and the first chamfer and the second chamfer are provided opposite to each other along the longitudinal direction.

In certain embodiments, a distance between the positive terminal closest to the negative terminal group in the positive terminal group and the negative terminal closest to the positive terminal group in the negative terminal group is greater than a distance between any two adjacent positive terminals or the distance between any two adjacent negative terminals.

In certain embodiments, each of the contact portions has an abutting surface and an oblique surface facing toward the mating component in the insertion slot, the abutting surface is in contact with the first contact pad or the second contact pad to form an electrical connection therebetween, the first contact pad has a first bottom edge adjacent to a bottom edge of the mating component, the second contact pad has a second bottom edge adjacent to the bottom edge of the mating component, and a height difference between the first bottom edge and the bottom edge of the mating component is equal to a height difference between the second bottom edge and the bottom edge of the mating component and is greater than a height difference between a bottom end and a top end of each of the contact portions.

In certain embodiments, the fixing portion has a positioning plate and two retaining arms extending upward from the positioning plate, the two retaining arms are respectively located at two opposite sides of the neck portion along the lateral direction, the first protruding portion is formed by protruding from the positioning plate in a thickness direction thereof, each of the two retaining arms is protrudingly provided with one of the second protruding portions along a respective thickness direction, each of the second protruding portions extends downward to the positioning plate, and a dimension of the first protruding portion extending along the lateral direction is greater than a dimension of each of the second protruding portions extending along the lateral direction.

In certain embodiments, the positioning plate has two soldering legs extending downward, the soldering legs, the positioning plate and the neck portion of a same one of the terminals are provided to be coplanar, for the same one of the terminals, a distance between one of the two soldering legs and a central line of the neck portion and a distance between the other of the two soldering legs and the central line of the neck portion are not equal to each other, a strip connecting portion is protrudingly provided on a lower end of the positioning plate, the strip connecting portion is located between the two soldering legs, and the central line of the neck portion passes downward through the strip connecting portion.

In certain embodiments, the at least one first contact pad is integrally connected to a first conductive layer, the at least one second contact pad is integrally connected to a second conductive layer, the mating component further has a plurality of mounting through holes running through a thickness direction thereof, two of the mounting through holes run through the first conductive layers of the two surfaces of the mating component, two others of the mounting through holes run through the second conductive layers of the two surfaces of the mating component, the mating component further comprises two positive cables and two negative cables, the two positive cables are connected to the first conductive layers, and the two negative cables are connected to the second conductive layers.

Compared to the related art, the electrical connector assembly and the electrical connector thereof according to the present invention have the following beneficial effects:

In the present invention, each terminal has a fixing portion, and a neck portion extends upward from the fixing portion. Gaps exist between the neck portion and the inner wall surfaces of the corresponding terminal slot in the longitudinal direction and the lateral direction. Two contact arms extend upward from the neck portion, and the two contact arms are respectively provided with two contact portions laterally protruding into the insertion slot to clamp the mating component. Thus, the neck portion may swing along the lateral direction, and even though the mating component is obliquely inserted into the insertion slot, the contact portion of one of the contact arms is subjected to the abutting force of the mating component and deviates toward a side away from the center of the insertion slot, and the neck portion swings following the deviation of the contact arm to further drive the other contact arm to deviate toward a side adjacent to the mating component, such that the mating component may be stably clamped between the two contact portions of the terminal, thereby ensuring that the electrical connector and the mating component may be stably mated. In addition, along the longitudinal direction, the fixing portion is provided with a first protruding portion and two second protruding portions with opposite protruding directions thereof and respectively interfere with the two side walls of the corresponding terminal slot. The first protruding portion is at least partially located right below the neck portion, and the two second protruding portions are located adjacent to two opposite side edges of the fixing portion in the lateral direction. Thus, when the terminal is inserted into the corresponding terminal slot, the terminal does not deviate in the longitudinal direction, thereby ensuring that the terminal is mounted at the exact center of the corresponding terminal slot, preventing the terminal from being inserted obliquely, such that the terminal may be in direct contact with the mating component, thereby ensuring that the electrical connector and the mating component may be stably mated.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective exploded view of an electrical connector assembly according to certain embodiments of the present invention.

FIG. 2 is a partial perspective sectional view of an electrical connector assembly according to certain embodiments of the present invention.

FIG. 3 is an enlarged view of a portion A of FIG. 2.

FIG. 4 is a bottom schematic view of an electrical connector according to certain embodiments of the present invention.

FIG. 5 is a sectional schematic view of an electrical connector assembly according to certain embodiments of the present invention, in which the mating component is not inserted into the electrical connector.

FIG. 6 is a sectional schematic view of an electrical connector assembly according to certain embodiments of the present invention, in which the mating component is inserted into the electrical connector.

FIG. 7 is a partial sectional view of an electrical connector assembly along a longitudinal direction and a lateral direction according to certain embodiments of the present invention.

FIG. 8 is a schematic view of an electrical connector assembly according to certain embodiments of the present invention, in which the mating component is obliquely inserted into the electrical connector.

FIG. 9 is a partial sectional view of a terminal of an electrical connector assembly according to certain embodiments of the present invention.

FIG. 10 is a front view of FIG. 9.

FIG. 11 is a schematic view of an electrical connector assembly according to certain embodiments of the present invention, in which the green solder mask on the mating component is removed.

FIG. 12 is a sectional view of FIG. 11 in the B-B direction.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated. As used herein, the terms “comprising”, “including”, “carrying”, “having”, “containing”, “involving”, and the like are to be understood to be open-ended, i.e., to mean including but not limited to.

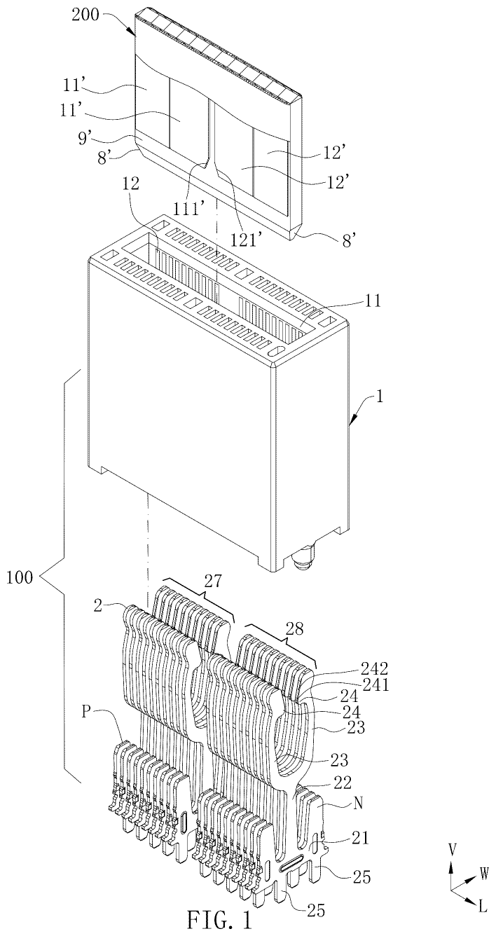

The description will be made as to the embodiments of the present invention in conjunction with the accompanying drawings in FIGS. 1-12. In accordance with the purposes of this invention, as embodied and broadly described herein, this invention, in one aspect, relates to an electrical connector assembly with an electrical connector.

As shown in FIG. 1 to FIG. 12, for convenience of understanding the accompanying drawings, the L-axis represents a longitudinal direction, the W-axis represents a lateral direction, and the V-axis represents an up-down direction.

FIG. 1 to FIG. 12 show an electrical connector assembly 1000 with an electrical connector 100 according to certain embodiments of the present invention. The electrical connector assembly 1000 includes the electrical connector 100 and a mating component 200 mated therewith (in the present embodiment, the mating component 200 is a card-type power module, and in other embodiments, the mating component 200 may be a mating connector or a circuit board, etc.). The electrical connector 100 has an insulating body 1, and an insulating body 1 is provided along the longitudinal direction. Along the up-down direction, the insulating body 1 is concavely provided with an insertion slot 11 downward from top thereof, and the insertion slot 11 extends along the longitudinal direction. A plurality of terminals 2 are provided in the insertion slot 11 at intervals along the longitudinal direction. Along the lateral direction perpendicular to the longitudinal direction and the up-down direction, each of two opposite surfaces of the mating component 200 is provided with at least one contact pad 1′ (in the present embodiment, four contact pads 1′ are provided on each surface of the mating component 200). The mating component 200 is inserted downward into the insertion slot 11, such that the contact pads 1′ and the terminals 2 are in contact with each other.

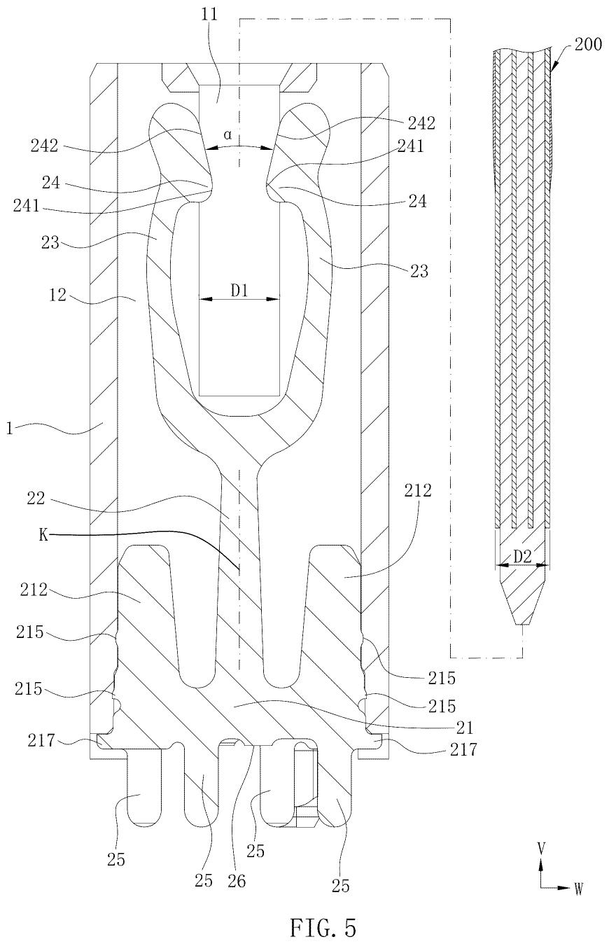

As shown in FIG. 1 and FIG. 5, the insulating body 1 is concavely provided with the insertion slot 11, and the insertion slot 11 has a first dimension D1 along the lateral direction which is perpendicular to the longitudinal direction (in the present embodiment, a width of the first dimension is 2.38 mm). The insulating body 1 is further concavely provided with a plurality of terminal slots 12 upward from bottom thereof. The terminal slots 12 are arranged along the longitudinal direction. Each terminal slot 12 is in communication with the insertion slot 11 along the up-down direction, and each terminal slot 12 is in communication with the two opposite sides of the insertion slot 11 along the lateral direction. The terminals 2 one-to-one correspond to the terminal slots 12, and each terminal 2 is retained in a corresponding terminal slot 12.

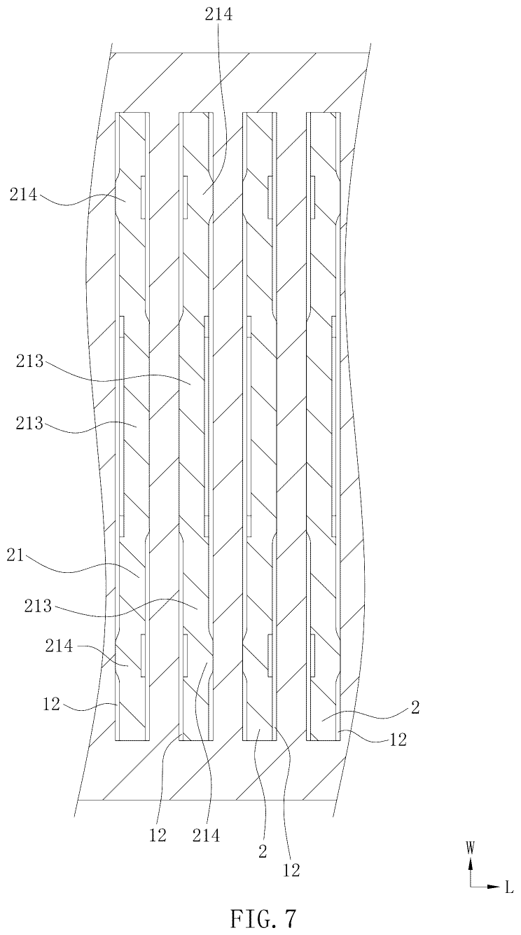

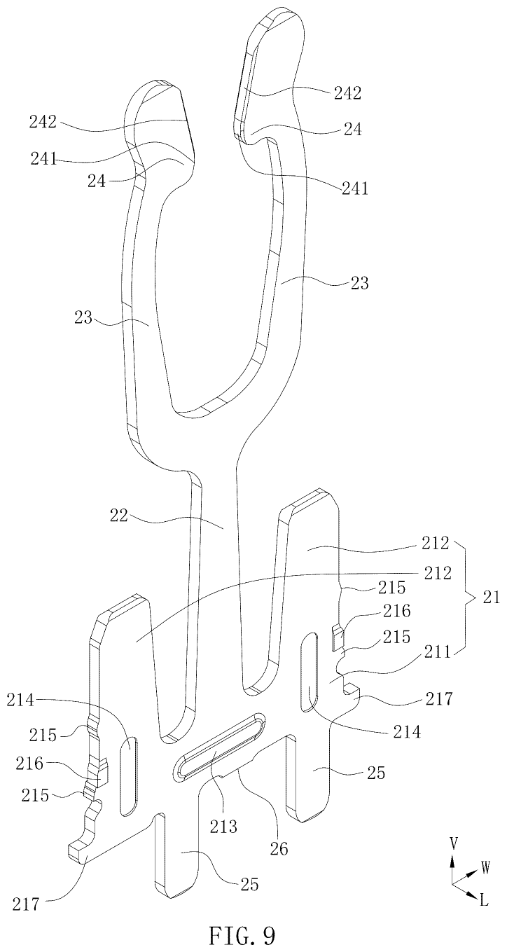

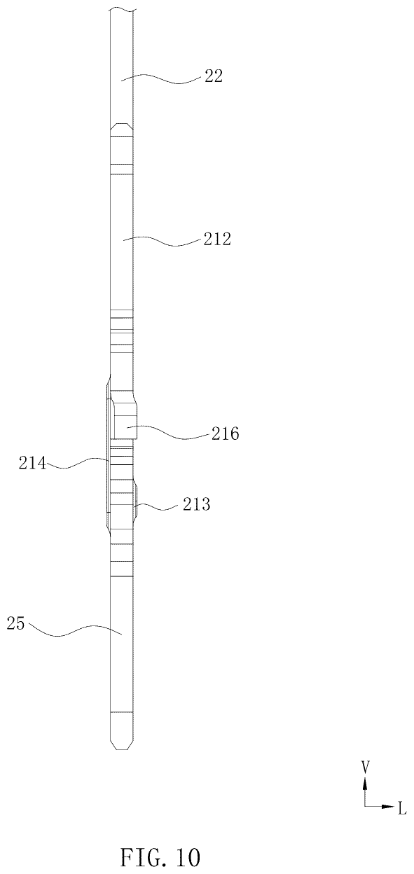

As shown in FIG. 1, FIG. 5, FIG. 7, FIG. 9 and FIG. 10, the terminals 2 are blanking terminals 2 in flat plate shapes, and the plate surface of each terminal 2 is perpendicular to the longitudinal direction. Each terminal 2 has a fixing portion 21, and the fixing portions 21 of the terminals 2 are arranged in a row along the longitudinal direction. Each terminal 2 has a neck portion 22 extending upward from the fixing portion 21 and capable of swinging along the lateral direction. Two contact arms 23 extend upward from the neck portion 22, and the two contact arms 23 protrude toward each other to form two contact portions 24 protruding into the insertion slot 11 to be mated with the contact pads 1′ of the mating component 200. A lower end of the fixing portion 21 is provided with two soldering legs 25 protruding downward and a strip connecting portion 26 located between the two soldering legs 25 along the lateral direction. The soldering legs 25 are used to extend downward to be inserted into through holes of a circuit board (not shown, same below).

As shown in FIG. 5, FIG. 7 and FIG. 9, the fixing portion 21 is provided in a plate shape, and a thickness direction of the fixing portion 21 is consistent with the longitudinal direction. The fixing portion 21, along its thickness direction, is protrudingly provided with at least one first protruding portion 213 and at least two second protruding portions 214 having protruding directions opposite to that of the first protruding portion 213 (in the present embodiment, one first protruding portion 213 and two second protruding portions 214 are provided). The first protruding portion 213 is at least partially located right below the neck portion 22, the two second protruding portions 214 are located adjacent to two opposite side edges of the fixing portion 21 in the lateral direction, and a dimension of the first protruding portion 213 extending along the lateral direction is greater than a dimension of each second protruding portion 214 extending along the lateral direction. Specifically, the fixing portion 21 of each terminal 2 has a positioning plate 211 and two retaining arms 212 extending upward from the positioning plate 211. The two retaining arms 212 are respectively located at two opposite sides of the neck portion 22 along the lateral direction. Along the up-down direction, a length of each retaining arm 212 of each terminal 2 is less than a length of the neck portion 22, and the length of each retaining arm 212 is greater than a length of each soldering leg 25. A first protruding portion 213 is protrudingly provided in a thickness direction of the positioning plate 211, and the first protruding portion 213 is provided longitudinally along the lateral direction. Each of the two retaining arms 212 is protrudingly provided with a second protruding portion 214 along a respective thickness direction, and a protruding direction of the second protruding portion 214 is opposite to a protruding direction of the first protruding portion 213. The second protruding portion 214 is provided longitudinally along the up-down direction, and each second protruding portion 214 extends downward to the positioning plate 211. In other words, an upper portion of each second protruding portion 214 is provided to protrude from the corresponding retaining arm 212, and a lower portion of each second protruding portion 214 is provided to protrude from the positioning plate 211. When the terminal 2 is retained in the corresponding terminal slot 12, the first protruding portion 213 and the second protruding portion 214 respectively interfere with two opposite inner walls of the corresponding terminal slot 12 along the longitudinal direction. A side edge of each retaining arm 212 away from the neck portion 22 along the lateral direction is laterally protrudingly provided with two protruding barbs 215. The two protruding barbs 215 on each retaining arm 212 are provided at an interval along the up-down direction, and each retaining arm 212 is further protrudingly provided with a protruding bump 216 between the two protruding barbs 215. A protruding direction of the protruding bump 216 is identical to the protruding direction of the first protruding portion 213, and the protruding bump 216 and the first protruding portion 213 collectively interfere with the inner wall of the corresponding terminal slot 12 along the thickness direction of the positioning plate 211. Specifically, along the longitudinal direction, the protruding directions and the protruding distances of the protruding bump 216 and the first protruding portion 213 are identical, such that the two protruding bumps 216 of the two retaining arms 212 and the first protruding portion 213 may be coplanar to abut against and interfere with the inner wall of the terminal slot 12. The protruding barbs 215 of the two retaining arms 212 interfere with two other inner walls of the corresponding terminal slot 12 along the lateral direction. When the terminal 2 is mounted in the corresponding terminal slot 12, the two protruding bumps 216 and the first protruding portion 213 collectively interfere with one inner wall of the corresponding terminal slot 12 along the longitudinal direction, and the two second protruding portions 214 collectively interfere with the other inner wall of the corresponding terminal slot 12 along the longitudinal direction, such that in the process of mounting the terminal 2 in the corresponding terminal slot 12, the terminal 2 may be provided to be centered in the corresponding terminal slot 12 along the longitudinal direction. The protruding barbs 215 of the two retaining arms 212 interfere with two other inner walls of the corresponding terminal slot 12 along the lateral direction. Thus, the terminal 2 is retained in the longitudinal direction and the lateral direction, such that the terminal 2 may be stably retained in the corresponding terminal slot 12. Each of two opposite side edges of the positioning plate 211 along the lateral direction is further protrudingly provided with a position limiting portion 217. When the terminal 2 is mounted in the corresponding terminal slot 12, the two position limiting portions 217 respectively protrude out of the two opposite sides of the corresponding terminal slot 12 in the lateral direction, and along the up-down direction, the position limiting portions 217 respectively abut against the bottom ends of the two opposite side walls of the corresponding terminal slot 12 in the lateral direction, thereby limiting the terminal 2 from excessively moving upward.

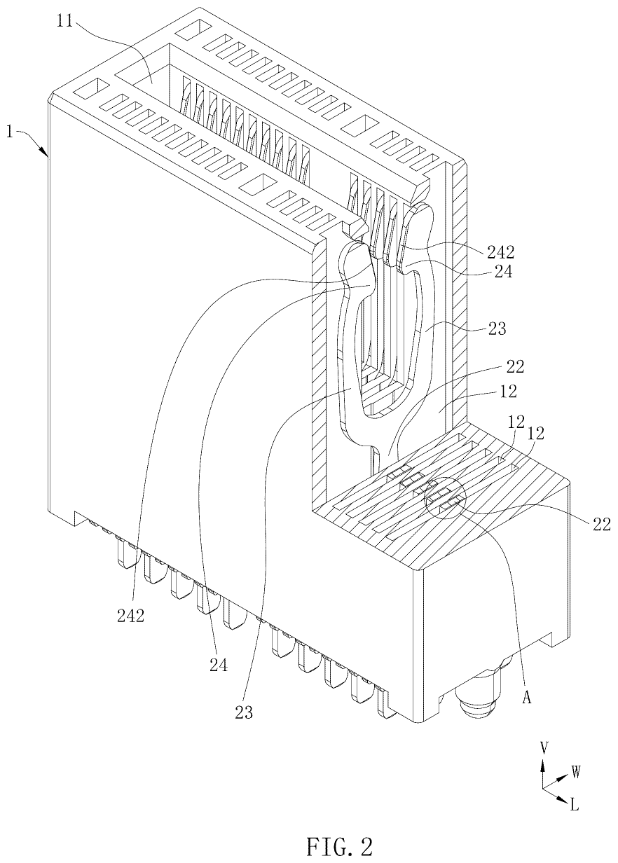

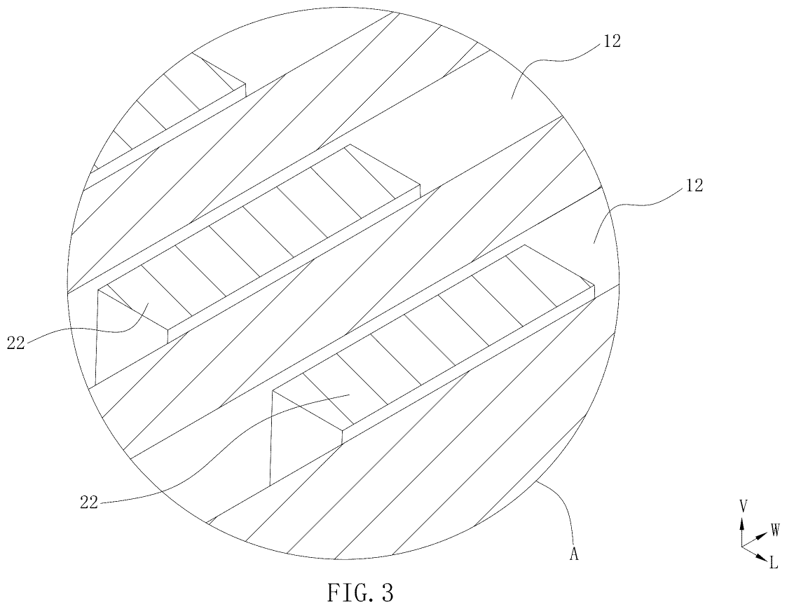

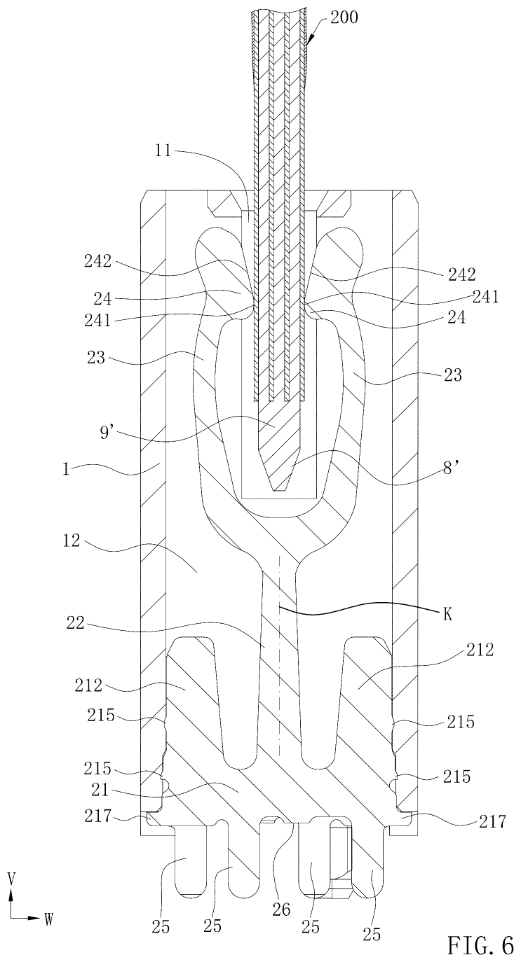

As shown in FIG. 2, FIG. 3, FIG. 5, FIG. 6 and FIG. 9, each neck portion 22 extends upward from the upper end of the positioning plate 211, and along the lateral direction, the widths of an upper end and a lower end of the neck portion 22 are greater than a width of a middle position of the neck portion 22, thus preventing the neck portion 22 from breaking at the upper end and the lower end thereof in the swinging process along the lateral direction, and increasing the elasticity of the neck portion 22 with the shorter width of the middle position of the neck portion 22 in the lateral direction, thereby allowing the neck portion 22 to swing in the lateral direction. When each terminal 2 is fixed in the corresponding terminal slot 12, gaps exist between the neck portion 22 and the inner wall surfaces of the corresponding terminal slot 12 in the longitudinal direction and the lateral direction, such that the neck portion 22 may freely move in the corresponding terminal slot 12 along the longitudinal direction and the lateral direction, ensuring that the neck portion 22, when swinging along the lateral direction, does not collide with the inner wall surfaces of the corresponding terminal slot 12.

As shown in FIG. 1, FIG. 5, FIG. 6 and FIG. 9, the two contact arms 23 of each terminal 2 are connected to each other at the upper end of the neck portion 22, and the two contact arms 23 are provided in a U-shape (in other embodiments, the shapes of the two contact arms 23 may be unlimited). A length of each contact arm 23 is greater than or equal to the length of the neck portion 22 (in the present embodiment, the length of each contact arm 23 is greater than the length of the neck portion 22). The widths of an upper end and a lower end of each contact arm 23 in the lateral direction is greater than a width of a middle location of the contact arm 23, thus increasing the elasticity of the contact arm 23, and preventing the contact arm 23 to break at the upper end and the lower end thereof in the swinging process, such that the contact arm 23 may have a greater deviation in the lateral direction, which is convenient to be stably mated with the mating component 200.

As shown in FIG. 5, FIG. 6 and FIG. 9, each contact arm 23 has a contact portion 24, and the two contact portions 24 of each terminal 2 are provided to be opposite to each other along the lateral direction. The two contact portions 24 are located closer to the center of the insertion slot 11 relative to two opposite inner side walls of the insertion slot 11, and a distance between each of the contact portions 24 and the inner side wall of the insertion slot 11 located at a same side of the insertion slot 11 is greater than 0.2 mm. In other words, the two contact portions 24 of each terminal 2 respectively protrude into the insertion slot 11 from the two opposite sides of the insertion slot 11 in the lateral direction, and each contact portion 24 has an abutting surface 241 and an oblique surface 242 facing toward the mating component 200 in the insertion slot 11. The abutting surface 241 is located at a side of each contact portion 24 adjacent to the center of the insertion slot 11, and a distance between the abutting surface 241 and the inner side wall of the insertion slot 11 located at the same side thereof is greater than 0.2 mm. The abutting surface 241 is used to be in contact with the contact pad 1′ of the mating component 200 to form an electrical connection therebetween. The oblique surface 242 extends obliquely toward the center of the insertion slot 11 downward from top thereof. Further, an included angle a between the oblique surfaces 242 of the two contact portions 24 of each terminal 2 is less than 30° (in the present embodiment, the included angle a between the oblique surfaces 242 of the two contact portions 24 of each terminal 2 is) 26°. Thus, the oblique surfaces 242 may guide the mating component 200 to enter between the two contact portion 24, and the included angle a between the two oblique surfaces 242 is less than 30°, which may reduce the insertion force of the mating component 200, allowing the mating component 200 to be conveniently inserted between the two contact portions 24.

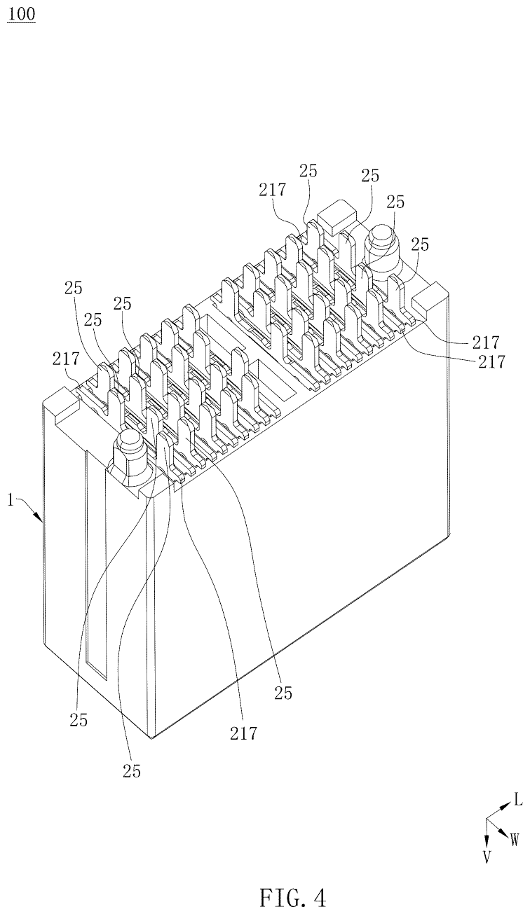

As shown in FIG. 1, FIG. 4, FIG. 5 and FIG. 9, the positioning plate 211 has two soldering legs 25 extending downward, and the soldering legs 25 are used to be soldered to the circuit board. Along the up-down direction, the soldering legs 25, the positioning plate 211 and the neck portion 22 of the same terminal 2 are provided to be coplanar, and for the same terminal 2, a distance between one of the two soldering legs 25 and a central line K of the neck portion 22 and a distance between the other of the two soldering legs 25 and the central line K of the neck portion 22 are not equal to each other. Specifically, a distance between the two soldering legs 25 is less than the distance between the two retaining arms 212 along the lateral direction, and at least one of the soldering legs 25 is staggered from the two retaining arms 212 of the same terminal 2 are staggered along the up-down direction (in the present embodiment, one of the two soldering legs 25 is staggered from the two retaining arms 212, and the other soldering leg 25 is located right below one of the retaining arms 212. In other embodiments, it is possible that the two soldering legs 25 are both staggered from the two retaining arms 212). Further, one of the two soldering legs 25 is located closer to the central line K of the neck portion 22 relative to the other soldering leg 25. A strip connecting portion 26 is further protrudingly provided on a lower end of the positioning plate 211. The strip connecting portion 26 is located between the two soldering legs 25, and the strip connecting portion 26 is at least partially located right below the neck portion 22. Further, the central line K of the neck portion 22 passes downward through the strip connecting portion 26. Thus, when each terminal 2 is inserted into the corresponding terminal slot 12, the strip connecting portion 26 is located closer to the center of the terminal 2, such that the terminal 2 may be inserted vertically upward into the corresponding terminal slot 12, and the terminal 2 does not deviate along the lateral direction, thereby preventing the terminal 2 from deviating in the insertion process. Along the longitudinal direction, the soldering legs 25 of the two adjacent terminals 2 are staggered from each other, thereby preventing the distances between the soldering legs 25 of the two adjacent terminals 2 from being too close and causing soldering bridging between the soldering legs 25 of the two adjacent terminals 2.

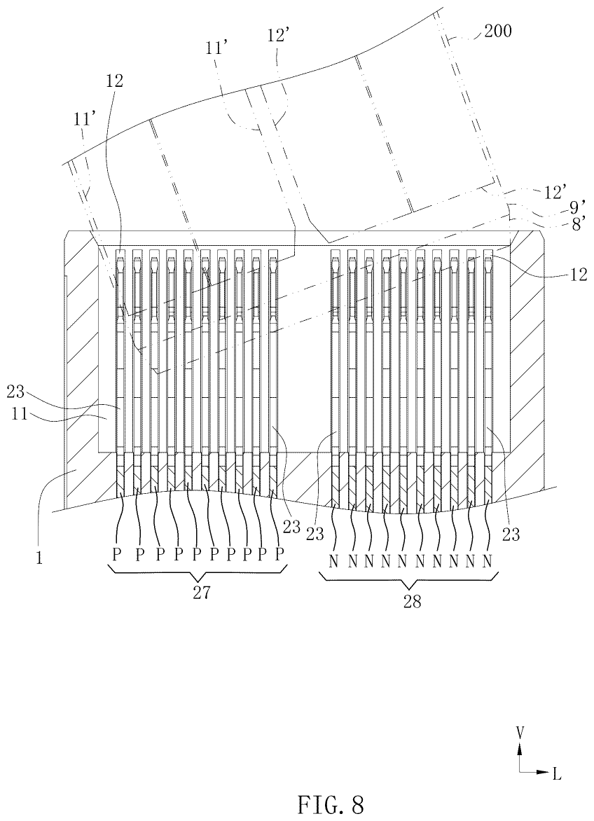

As shown in FIG. 1, FIG. 5 and FIG. 8, the terminals 2 include a positive terminal group 27 formed by a plurality of positive terminals P arranged at consecutive intervals and a negative terminal group 28 formed by a plurality of negative terminals N arranged at consecutive intervals. The positive terminal group 27 includes at least 10 of the positive terminals P (in the present embodiment, the positive terminal group 27 includes 10 of the positive terminals P), the negative terminal group 28 comprises at least 10 of the negative terminals N (in the present embodiment, the negative terminal group 28 includes 10 of the negative terminals N), and the positive terminal group 27 and the negative terminal group 28 are arranged to be adjacent to each other in the longitudinal direction. A distance between the positive terminal group 27 and the negative terminal group 28 along the longitudinal direction is greater than a distance between any two adjacent positive terminals P and a distance between any two adjacent negative terminals N. Specifically, along the longitudinal direction, the 10 positive terminals P are arranged at consecutive intervals, the contact portions 24 of 5 of the positive terminals P located away from the negative terminal group 28 are simultaneously in contact and conductive with one contact pad 1′ located at the same side of the mating component 200, and the contact portions 24 of the other 5 positive terminals P are simultaneously in contact and conductive with another contact pad 1′ located at the same side of the mating component 200. Further, the contact portion 24 of each positive terminal P, through its cutting surface, abuts against the corresponding contact pad 1′. Similarly, along the longitudinal direction, the 10 negative terminals N are arranged at consecutive intervals, the contact portions 24 of 5 of the negative terminals P located away from the positive terminal group 27 are simultaneously in contact and conductive with a further contact pad 1′ located at the same side of the mating component 200 and different from the aforementioned two contact pads 1′, and the contact portions 24 of the other 5 negative terminals P are simultaneously in contact and conductive with yet another contact pad 1′ located at the same side of the mating component 200. Further, the contact portion 24 of each negative terminal P, through its cutting surface, abuts against the corresponding contact pad 1′, such that one contact pad 1′ may be simultaneously in contact with more terminals 2, thereby increasing the current carrying capacity of the mating component 200 and the electrical connector 100, which is convenient for transmitting a large current. Further, one contact pad 1′ may be conductively connected to a plurality of terminals 2, thus increasing the conductive paths of the contact pad 1′ and the electrically connector 100, and preventing the temperature of the electrical connector 100 from increasing in an excessively rapid manner in the process of transmitting the large current and affecting the electrical transmission between the electrical connector 100 and the mating component 200. In addition, a distance between the positive terminal P closest to the negative terminal group 28 in the positive terminal group 27 and the negative terminal N closest to the positive terminal group 27 in the negative terminal group 28 is greater than the distance between any two adjacent positive terminals P or the distance between any two adjacent negative terminals N, which may further prevent the positive terminals P from being in contact with the contact pads 1′ for transmitting negative power and prevent the negative terminals N from being in contact with the contact pads 1′ for transmitting positive power when the mating component 200 is obliquely inserted into the insertion slot 11, thereby preventing from short-circuiting.

As shown in FIG. 1, FIG. 5 and FIG. 6, the mating component 200 is inserted into the insertion slot 11 downward from top thereof, and the two contact portions 24 of each terminal 2 respectively protrude into the insertion slot 11 from the two opposite sides of the insertion slot 11 in the lateral direction and clamp the mating component 200, such that the two contact portions 24 of each terminal 2 are mated with the contact pads 1′ on the two opposite surfaces of the mating component 200 in its thickness direction (that is, the lateral direction). Along the lateral direction (that is, along the thickness direction of the mating component 200), the two opposite surfaces of the mating component 200 are provided with the contact pads 1′, and the mating component 200 has a second dimension D2 along the lateral direction (in the present embodiment, the second dimension D2 is 1.57 mm, and its manufacturing tolerance is ±0.13 mm). The first dimension D1 is greater than the second dimension D2, and a difference between the first dimension D1 and the second dimension D2 is greater than or equal to 0.4 mm (in the present embodiment, the difference between the first dimension D1 and the second dimension D2 is 0.405 mm). In other words, the first dimension D1 is at least 0.4 mm longer than the second dimension D2. When the mating component 200 is inserted into the insertion slot 11, along the lateral direction, a distance between a surface of the mating component 200 and the inner side wall of the insertion slot 11 located at a same side of a central line of the insertion slot is greater than or equal to 0.2 mm. That is, when the mating component 200 is inserted into the insertion slot 11, along the lateral direction, a distance between the surface of the mating component 200 and the inner side wall of the insertion slot 11 right opposite thereto is greater than or equal to 0.2 mm.

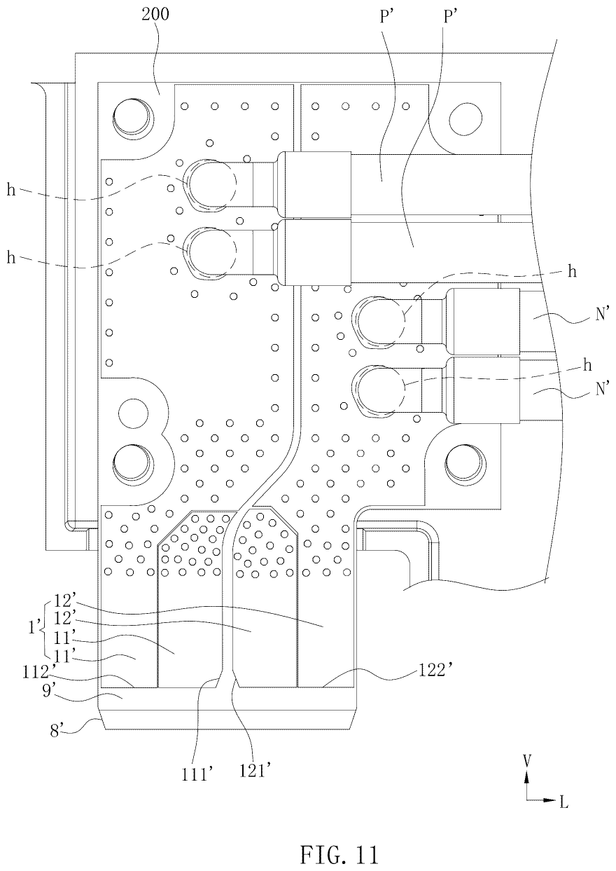

As shown in FIG. 1, FIG. 5, FIG. 8 and FIG. 11, the contact pads 1′ are respectively provided on the two surfaces of mating component 200 along the thickness direction thereof, and a plurality of contact pads 1′ are provided. The contact pads 1′ located on the same surface of the mating component 200 include at least one first contact pad 11′ and at least one second contact pad 12′ adjacent to each other along the longitudinal direction. The first contact pad 11′ and the positive terminal group 27 mate with each other, and the second contact pad 12′ and the negative terminal group 28 mate with each other. A lower end of a side of the first contact pad 11′ adjacent to the second contact pad 12′ is provided with a first chamfer 111′, and a lower end of a side of the second contact pad 12′ adjacent to the first contact pad 11′ is provided with a second chamfer 121′. The first chamfer 111′ and the second chamfer 121′ are provided opposite to each other along the longitudinal direction. In addition, the first contact pad 11′ has a first bottom edge 112′ adjacent to the bottom edge of the mating component 200, and the second contact pad 12′ has a second bottom edge 122′ adjacent to the bottom edge of the mating component 200. Specifically, two first contact pads 11′ and two second contact pads 12′ are located on the same surface of the mating component 200 and are provided at intervals along the longitudinal direction. The two first contact pads 11′ are provided to be adjacent to each other and mate with the positive terminal group 27, and the two second contact pads 12′ are provided to be adjacent to each other and mate with the negative terminal group 28. In other words, the contact pads 1′ located on the same surface of the mating component 200 include two first contact pads 11′ and two second contact pads 12′ adjacent to each other along the longitudinal direction. The two first contact pads 11′ located at the same side of the mating component 200 along the longitudinal direction are provided to be adjacent to each other. Of the two first contact pads 11′, one first contact pad 11′ adjacent to the second contact pads 12′ is provided with the first chamfer 111′, and the first chamfer 111′ is located at the lower end of the first contact pad 11′ adjacent to the second contact pads 12′. Similarly, the two second contact pads 12′ located at the same side of the mating component 200 along the longitudinal direction are provided to be adjacent to each other. Of the two second contact pads 12′, one second contact pad 12′ adjacent to the first contact pads 11′ is provided with the second chamfer 121′, and the second chamfer 121′ is located at the lower end of the second contact pad 12′ adjacent to the first contact pads 11′. The first chamfer 111′ and the second chamfer 121′ are provided opposite to each other, such that a distance between the lower ends of the first contact pad 11′ and the second contact pad 12′ adjacent to each other along the longitudinal direction is greater than a distance between the upper ends of the first contact pad 11′ and the second contact pad 12′ adjacent to each other. In addition, the distance between the first contact pad 11′ and the second contact pad 12′ adjacent to each other located at the same side of the mating component 200 along the longitudinal direction is greater than the distance between the two first contact pads 11′ located at the same side of the mating component 200, and is greater than the distance between the two second contact pads 12′ located at the same side of the mating component 200. Each first contact pad 11′ is mated with at least 5 of the positive terminals P. Further, at least 5 of the positive terminals P arranged at consecutive intervals in the positive terminal group 27 are simultaneously in contact with the two first contact pads 11′ right opposite to each other on the two opposite surfaces of the mating component 200, and the contact portion 24 of each positive terminal P, through its cutting surface, is mated with the first contact pads 11′. Each second contact pad 12′ is mated with at least 5 of the negative terminals N. Further, at least 5 of the negative terminals N arranged at consecutive intervals in the negative terminal group 28 are simultaneously in contact with the two second contact pads 12′ right opposite to each other on the two opposite surfaces of the mating component 200, and the contact portion 24 of each negative terminal N, through its cutting surface, is mated with the second contact pads 12′.

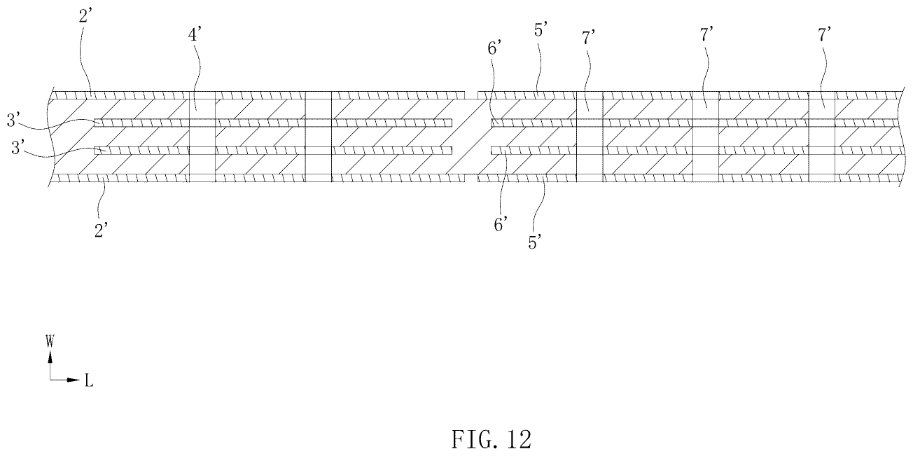

As shown in FIG. 1, FIG. 5, FIG. 8, FIG. 11 and FIG. 12, on the two surfaces of the mating component 200 in its thickness direction, each first contact pad 11′ is integrally connected to a first conductive layer 2′. Along the thickness direction of the mating component 200, at least one first inner conductive layer 3′ exists between two first conductive layers 2′ of the two surfaces of the mating component 200. A plurality of first conductive holes 4′ run and conduct through the first conductive layers 2′ of the two surfaces of the mating component 200 and the first inner conductive layer 3′ along the thickness direction of the mating component 200. Each second contact pad 12′ is integrally connected to a second conductive layer 5′, and the second conductive layer 5′ and the first conductive layer 2′ are at an interval along the longitudinal direction. Along the thickness direction of the mating component 200, at least one second inner conductive layer 6′ exists between two second conductive layers 5′. The second inner conductive layer 6′ and the first inner conductive layer 3′ are coplanar in the lateral direction, and the second inner conductive layer 6′ and the first inner conductive layer 3′ are at an interval along the longitudinal direction. A plurality of second conductive holes 7′ run and conduct through the second conductive layers 5′ of the two surfaces of the mating component 200 and the second inner conductive layer 6′ along the thickness direction of the mating component 200. In addition, along the thickness direction of the mating component 200, the outer side of each of the first conductive layers 2′ and the second conductive layers 5′ on the two surfaces of the mating component 200 is covered by a solder resisting layer (not numbered, same below), and outer sides of the first contact pads 11′ and the second contact pad 12′ are not covered by the solder resisting layer. Further, in the present embodiment, along the thickness direction of the mating component 200, each of the two surfaces of the mating component 200 is provided with two first conductive layers 2′ and two second conductive layers 5′. The two first conductive layers 2′ on the same surface of the mating component 200 are at an interval along the longitudinal direction, and the two second conductive layers 5′ on the same surface of the mating component 200 are at an interval along the longitudinal direction. In addition, a lower end of each first conductive layer 2′ is connected to a corresponding first contact pad 11′, and a lower end of each second conductive layer 5′ is connected to a corresponding second contact pad 12′ (in other embodiments, along the thickness direction of the mating component 200, each of the two surfaces of the mating component 200 is provided only with one first conductive layer 2′ and one second conductive layer 5′. The first conductive layer 2′ is integrally connected to the two first contact pad 11′ on the same surface of the mating component 200. That is, the upper ends of the two first contact pad 11′ on the same surface of the mating component 200 are simultaneously connected to one first conductive layer 2′. Similarly, the second conductive layer 5′ is integrally connected to the two second contact pad 12′ on the same surface of the mating component 200. That is, the upper ends of the two second contact pad 12′ on the same surface of the mating component 200 are simultaneously connected to one second conductive layer 5′). In addition, along the thickness direction of the mating component 200, two first inner conductive layers 3′ exist between the two first conductive layers 2′ of the two surfaces of the mating component 200, and the two first inner conductive layers 3′ are provided to be stacked in the thickness direction of the mating component 200. The first conductive holes 4′ run and conduct through the first conductive layers 2′ of the two surfaces of the mating component 200 and the two first inner conductive layers 3′ along the thickness direction of the mating component 200. Similarly, along the thickness direction of the mating component 200, two second inner conductive layers 6′ exist between the two second conductive layers 5′ of the two surfaces of the mating component 200, and the two second inner conductive layers 6′ are provided to be stacked in the thickness direction of the mating component 200. The two second inner conductive layers 6′ and the two first inner conductive layers 3′ one-to-one correspond to each other in the longitudinal direction, and in the longitudinal direction, any one of the second inner conductive layers 6′ and the corresponding first inner conductive layer 3′ are located on the same plane and are provided at an interval. The second conductive holes 7′ run and conduct through the second conductive layers 5′ of the two surfaces of the mating component 200 and the two second inner conductive layers 6′ along the thickness direction of the mating component 200.

As shown in FIG. 1, FIG. 5, FIG. 8, FIG. 11 and FIG. 12, the mating component 200 further has a plurality of mounting through holes h running through the thickness direction thereof. Two of the mounting through holes h run through the first conductive layers 2′ of the two surfaces of the mating component 200 and the two first inner conductive layers 3′ located between the two surfaces of the mating component 200, and two others of the mounting through holes h run through the second conductive layers 5′ of the two surfaces of the mating component 200 and the two second inner conductive layers 6′ located between the two surfaces of the mating component 200. The mating component 200 further includes two positive cables P′ and two negative cables N′. The two positive cables P′ are connected to the first conductive layers 2′, and the two negative cables N′ are connected to the second conductive layers 5′.

As shown in FIG. 1, FIG. 5, FIG. 8 and FIG. 11, a lower end of the mating component 200 has a guiding section 8′ and a clearance section 9′ located above the guiding section 8′. The guiding section 8′ is used to guide the mating component 200 to be inserted into the insertion slot 11. The first contact pads 11′ and the second contact pads 12′ are located above the clearance section 9′, and along the up-down direction, a height difference between the first bottom edge 112′ of the first contact pad 11′ and the bottom edge of the mating component 200 is equal to a height different between the second bottom edge 122′ of the second contact pad 11′ and the bottom edge of the mating component 200, and is greater than a height difference between the bottom end and the top end of the contact portion 1′. In other words, a lower end of each first contact pad 11′ and a lower end of each second contact pad 12′ are flush with each other. When the mating component 200 is obliquely inserted downward into the insertion slot 11, the clearance section 9′ allows gaps to exist between the first contact pads 1a′ and the negative terminals N, and allows gaps to exist between the second contact pads 12′ and the positive terminals P. Further, along the up-down direction, a distance between the lower end of the mating component 200 and the lower end of each first contact pad 11′is greater than or equal to 2.8 mm. In the present embodiment, the distance between the lower end of the mating component 200 and the lower end of each first contact pad 11′is equal to 2.8 mm, and its manufacturing tolerance is ±0.05 mm.

In sum, the electrical connector assembly 1000 according to certain embodiments of the present invention has the following beneficial effects:
(1) Each terminal 2 has a fixing portion 21, and a neck portion 22 extends upward from the fixing portion 21. Gaps exist between the neck portion 22 and the inner wall surfaces of the corresponding terminal slot 12 in the longitudinal direction and the lateral direction. Two contact arms 23 extend upward from the neck portion 22, and the two contact arms 23 are respectively provided with two contact portions 24 laterally protruding into the insertion slot 11 to clamp the mating component 200. Thus, the neck portion 22 may swing along the lateral direction, and even though the mating component 200 is obliquely inserted into the insertion slot 11, the contact portion 24 of one of the contact arms 23 is subjected to the abutting force of the mating component 200 and deviates toward a side away from the center of the insertion slot 11, and the neck portion 22 swings following the deviation of the contact arm 23 to further drive the other contact arm 23 to deviate toward a side adjacent to the mating component 200, such that the mating component 200 may be stably clamped between the two contact portions 24 of the terminal 2, thereby ensuring that the electrical connector 100 and the mating component 200 may be stably mated. In addition, along the longitudinal direction, the fixing portion 21 is provided with a first protruding portion 213 and two second protruding portions 214 with opposite protruding directions thereof and respectively interfere with the two side walls of the corresponding terminal slot 12. The first protruding portion 213 is at least partially located right below the neck portion 22, and the two second protruding portions 214 are located adjacent to two opposite side edges of the fixing portion 21 in the lateral direction. Thus, when the terminal 2 is inserted into the corresponding terminal slot 12, the terminal 2 does not deviate in the longitudinal direction, thereby ensuring that the terminal 2 is mounted at the exact center of the corresponding terminal slot 12, preventing the terminal 2 from being inserted obliquely, such that the terminal 2 may be in direct contact with the mating component 200, thereby ensuring that the electrical connector 100 and the mating component 200 may be stably mated.
(2) A side edge of each retaining arm 212 away from the neck portion 22 along the lateral direction is laterally protrudingly provided with two protruding barbs 215, and the protruding barbs 215 of the two retaining arms 212 interfere with two other inner walls of the corresponding terminal slot 12 along the lateral direction, such that the terminal 2 may be retained in the corresponding terminal slot 12 in the lateral direction, and the movement of the terminal 2 is limited in the up-down direction. Each retaining arm 212 is protrudingly provided with the protruding bump 216 between the two protruding barbs 215, and the protruding direction of the protruding bump 216 is identical to the protruding direction of the first protruding portion 213. Thus, the two protruding bumps 216 and the first protruding portion 213 may be coplanar, such that the two protruding bumps 216 and the first protruding portion 213 collectively interfere with and abut against one inner wall of the terminal slot 12 in the longitudinal direction, thereby canceling the abutting force between the two second protruding portion 214 and the other inner wall of the corresponding terminal slot 12, such that the terminal 2 may be provided to be centered in the corresponding terminal slot 12.
(3) The soldering legs 25 of the two adjacent terminals 2 are provided to be staggered from each other, which may increase the distance between the soldering legs 25 of the two adjacent terminals 2, preventing from soldering bridging in the soldering process. The strip connecting portion 26 is protrudingly provided on the lower end of the positioning plate 211. The strip connecting portion 26 is located between the two soldering legs 25, and the central line K of the neck portion 22 passes downward through the strip connecting portion 26, such that the terminal 2 does not deviate toward a side along the lateral direction, thereby allowing the terminal 2 to be inserted into and centered in the corresponding terminal slot 12, preventing the terminal 2 from being inclined in the insertion process into the corresponding terminal slot 12 and causing the contact portions 24 of the terminal 2 to deviate, and ensuring that mating of the contact portions 24 and the contact pads 1′ of the mating component 200 is not affected in the assembly process.
(4) The oblique surface 242 extends obliquely toward the center of the insertion slot 11 downward from top thereof, such that the oblique surface 242 may guide the mating component 200 to be inserted downward between the two contact portions 24 of the terminal 2, which is convenient for the contact pads 1′ of the mating component 200 to be mated with the contact portions 24. Further, an included angle a between the oblique surfaces 242 of the two contact portions 24 of each terminal 2 is less than 30°, which may further reduce the insertion force of the mating component 200, thus making the insertion of the mating component 200 more convenient. Along the lateral direction, the distance between each of the contact portions 24 and the inner side wall of the insertion slot 11 located at a same side of the insertion slot 11 is greater than 0.2 mm, such that the contact portions 24 are located closer to the center of the insertion slot 11 compared to the contact portions 24 of a conventional connector with the insertion slot 11, thus reducing the distance between the two contact portions 24 of each terminal 2 in the lateral direction, allowing the two contact portions 24 of each terminal 2 to stably clamp and mate with the two sides of the mating component 200, and thereby making the mating between the electrical connector 100 and the mating component 200 more stable.
(5) Along the lateral direction, the insertion slot 11 has a first dimension D1, and the mating component 200 has a second dimension D2. The first dimension D1 is greater than the second dimension D2, and a difference between the first dimension D1 and the second dimension D2 is greater than or equal to 0.4 mm. Thus, the difference between the first dimension D1 and the second dimension D2 allows the mating component 200 to be inserted into the insertion slot 11 with a relatively large oblique angle, such that the operator does not have to insert the mating component 200 into the insertion slot 11 strictly in the up-down direction, thus making the operation convenient for the operator, and the anti-vibration effect of the terminal 2 is enhanced, thus preventing from ill contact due to excessive vibration.
(6) The lower end of a side of the first contact pad 11′ adjacent to the second contact pad 12′ is provided with the first chamfer 111′, and the lower end of a side of the second contact pad 12′ adjacent to the first contact pad 11′ is provided with the second chamfer 121′. The first chamfer 111′ and the second chamfer 121′ are provided opposite to each other along the longitudinal direction, which may prevent the first contact pads 11′ for transmitting positive power from being in contact with the negative terminals N and prevent the second contact pads 12′ for transmitting negative power from being in contact with the positive terminals P when the mating component 200 is obliquely inserted into the insertion slot 11, thereby preventing from short-circuiting.
(7) A distance between the positive terminal group 27 and the negative terminal group 28 along the longitudinal direction is greater than a distance between two adjacent positive terminals P and a distance between two adjacent negative terminals N, thus further increasing the distance between the positive terminal group 27 and the negative terminal group 28, which may further prevent the first contact pads 11′ for transmitting positive power from being in contact with the negative terminals N and prevent the second contact pads 12′ for transmitting negative power from being in contact with the positive terminals P when the mating component 200 is obliquely inserted into the insertion slot 11, thereby preventing from short-circuiting, and facilitating transmission of a larger current.
(8) The terminals 2 are blanking terminals 2 in flat plate shapes, and the plate surface of each terminal 2 is perpendicular to the longitudinal direction. Thus, more terminals 2 may be mounted in the insulating body 1 along the longitudinal direction, which allows for more terminals 2 to be fixed on the insulating body 1 of the same size compared to conventional power connectors, thereby increasing the current carrying capacity of the electrical connector 100, such that the electrical connector 100 may be used to transmit a large current. Further, the cutting surfaces of the two contact portions 24 of each terminal are mated with the contact pads 1′ of the two surfaces of the mating component 200 in its thickness direction, such that a contact pad 1′ may be mated with the contact portions 24 of a plurality of terminals 2, thereby increasing the current conductive paths, and preventing the temperature of the electrical connector 100 from increasing in an excessively rapid manner and affecting the current conductive characteristics of the electrical connector 100 when the electrical connector 100 transmits a large current.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, configured to mate with a mating component, the electrical connector comprising:
an insulating body, concavely provided with an insertion slot downward from top thereof, wherein the insertion slot extends along a longitudinal direction, a plurality of terminal slots are arranged along the longitudinal direction, and each of the terminal slots is in communication with two opposite sides of the insertion slot along a lateral direction; and
a plurality of terminals, respectively retained in the terminal slots, each of the terminals has a fixing portion, a neck portion extends upward from the fixing portion, gaps exist between the neck portion and inner wall surfaces of a corresponding one of the terminal slots in the longitudinal direction and the lateral direction, two contact arms extend upward from the neck portion, the two contact arms protrude toward each other to form two contact portions protruding into the insertion slot, the fixing portion is protrudingly provided with at least one first protruding portion and at least two second protruding portions with protruding directions opposite to a protruding direction of the first protruding portion, the first protruding portion is at least partially located right below the neck portion, the two second protruding portions are respectively located adjacent to two opposite side edges of the fixing portion in the lateral direction, and along the longitudinal direction, the first protruding portion and the second protruding portions respectively interfere with two opposite inner walls of the corresponding one of the terminal slots;
wherein when the mating component is inserted downward into the insertion slot to be mated with the terminals, the two contact portions of each of the terminals respectively clamp the mating component along the lateral direction.

2. The electrical connector according to claim 1, wherein the fixing portion has a positioning plate and two retaining arms extending upward from the positioning plate, the two retaining arms are respectively located at two opposite sides of the neck portion along the lateral direction, the first protruding portion is formed by protruding from the positioning plate in a thickness direction thereof, each of the two retaining arms is protrudingly provided with one of the second protruding portions along a respective thickness direction, each of the second protruding portions extends downward to the positioning plate, and a dimension of the first protruding portion extending along the lateral direction is greater than a dimension of each of the second protruding portions extending along the lateral direction.

3. The electrical connector according to claim 2, wherein a side edge of each of the retaining arms away from the neck portion along the lateral direction is laterally protrudingly provided with two protruding barbs at an interval along an up-down direction, each of the retaining arms is protrudingly provided with a protruding bump between the two protruding barbs, a protruding direction of the protruding bump is identical to the protruding direction of the first protruding portion, the protruding bump and the first protruding portion collectively interfere with the inner wall of the corresponding one of the terminal slots along the thickness direction of the positioning plate, and the protruding barbs of the two retaining arms interfere with the two inner walls of the corresponding one of the terminal slots along the lateral direction.

4. The electrical connector according to claim 2, wherein the positioning plate has two soldering legs extending downward, two soldering legs of two adjacent ones of the terminals are provided to be staggered to each other, for a same one of the terminals, a distance between one of the two soldering legs and a central line of the neck portion and a distance between the other of the two soldering legs and the central line of the neck portion are not equal to each other, a strip connecting portion is protrudingly provided on a lower end of the positioning plate, the strip connecting portion is located between the two soldering legs, and the central line of the neck portion passes downward through the strip connecting portion.

5. The electrical connector according to claim 1, wherein a distance between each of the contact portions and an inner side wall of the insertion slot located at a same side of the insertion slot is greater than 0.2 mm, a side of each of the contact portions adjacent to the center of the insertion slot has an oblique surface, the oblique surface extends obliquely toward the center of the insertion slot downward from top thereof, and an included angle between the oblique surfaces of the two contact portions of each of the terminals is less than 30°.

6. An electrical connector assembly, comprising:
an electrical connector and a mating component mated with each other, wherein the electrical connector is the electrical connector according to claim 1, the terminals comprise a positive terminal group formed by a plurality of positive terminals arranged at consecutive intervals and a negative terminal group formed by a plurality of negative terminals arranged at consecutive intervals, the positive terminal group and the negative terminal group are provided to be arranged adjacent to each other in the longitudinal direction, each of two surfaces of the mating component along the lateral direction is provided with at least one first contact pad and at least one second contact pad adjacent to each other along the longitudinal direction, the first contact pad and the positive terminal group mate with each other, and the second contact pad and the negative terminal group mate with each other.

7. The electrical connector assembly according to claim 6, wherein a lower end of a side of the first contact pad adjacent to the second contact pad is provided with a first chamfer, a lower end of a side of the second contact pad adjacent to the first contact pad is provided with a second chamfer, and the first chamfer and the second chamfer are provided opposite to each other along the longitudinal direction.

8. The electrical connector assembly according to claim 6, wherein the positive terminal group comprises at least 10 of the positive terminals, the negative terminal group comprises at least 10 of the negative terminals, a distance between the positive terminal group and the negative terminal group along the longitudinal direction is greater than a distance between any two adjacent ones of the positive terminals and a distance between any two adjacent ones of the negative terminals, two first contact pads and two second contact pads are located on the same surface of the mating component and are provided at intervals along the longitudinal direction, the two first contact pads are provided to be adjacent to each other and mate with the positive terminal group, and the two second contact pads are provided to be adjacent to each other and mate with the negative terminal group.

9. The electrical connector assembly according to claim 6, wherein the terminals are blanking terminals in flat plate shapes, a plate surface of each of the terminals is perpendicular to the longitudinal direction, and cutting surfaces of the two contact portions of each of the terminals are mated with the first contact pads or the second contact pads of two surfaces of the mating component in a thickness direction thereof.

10. The electrical connector assembly according to claim 6, wherein along the lateral direction, the insertion slot has a first dimension, the mating component has a second dimension, the first dimension is greater than the second dimension, and a difference between the first dimension and the second dimension is greater than or equal to 0.4 mm.

11. An electrical connector assembly, comprising:
an electrical connector, having an insulating body, wherein the insulating body is concavely provided with an insertion slot downward from top thereof, the insertion slot extends along a longitudinal direction, a plurality of terminals are provided in the insertion slot at intervals along the longitudinal direction, each of the terminals has a fixing portion, a neck portion extends upward from the fixing portion and is capable of swinging along a lateral direction, two contact arms extend upward from the neck portion, the two contact arms protrude toward each other to form two contact portions protruding into the insertion slot, along the longitudinal direction, the fixing portion is protrudingly provided with at least one first protruding portion and at least two second protruding portions with protruding directions opposite to a protruding direction of the first protruding portion, the first protruding portion is at least partially located right below the neck portion, the two second protruding portions are respectively located adjacent to two opposite side edges of the fixing portion in the lateral direction, the terminals comprise a positive terminal group formed by a plurality of positive terminals arranged consecutively and a negative terminal group formed by a plurality of negative terminals arranged consecutively, and the positive terminal group and the negative terminal group are provided to be arranged adjacent to each other in the longitudinal direction; and
a mating component inserted into the insertion slot downward from top thereof, wherein each of two surfaces of the mating component in the lateral direction is provided with at least one first contact pad and at least one second contact pad adjacent to each other along the longitudinal direction, the first contact pad and the positive terminal group mate with each other, a lower end of a side of the first contact pad adjacent to the second contact pad is provided with a first chamfer, the second contact pad and the negative terminal group mate with each other, a lower end of a side of the second contact pad adjacent to the first contact pad is provided with a second chamfer, and the first chamfer and the second chamfer are provided opposite to each other along the longitudinal direction.

12. The electrical connector assembly according to claim 11, wherein a distance between the positive terminal closest to the negative terminal group in the positive terminal group and the negative terminal closest to the positive terminal group in the negative terminal group is greater than a distance between any two adjacent positive terminals or the distance between any two adjacent negative terminals.

13. The electrical connector assembly according to claim 11, wherein each of the contact portions has an abutting surface and an oblique surface facing toward the mating component in the insertion slot, the abutting surface is in contact with the first contact pad or the second contact pad to form an electrical connection therebetween, the first contact pad has a first bottom edge adjacent to a bottom edge of the mating component, the second contact pad has a second bottom edge adjacent to the bottom edge of the mating component, and a height difference between the first bottom edge and the bottom edge of the mating component is equal to a height difference between the second bottom edge and the bottom edge of the mating component and is greater than a height difference between a bottom end and a top end of each of the contact portions.

14. The electrical connector assembly according to claim 11, wherein the fixing portion has a positioning plate and two retaining arms extending upward from the positioning plate, the two retaining arms are respectively located at two opposite sides of the neck portion along the lateral direction, the first protruding portion is formed by protruding from the positioning plate in a thickness direction thereof, each of the two retaining arms is protrudingly provided with one of the second protruding portions along a respective thickness direction, each of the second protruding portions extends downward to the positioning plate, and a dimension of the first protruding portion extending along the lateral direction is greater than a dimension of each of the second protruding portions extending along the lateral direction.

15. The electrical connector assembly according to claim 14, wherein the positioning plate has two soldering legs extending downward, the soldering legs, the positioning plate and the neck portion of a same one of the terminals are provided to be coplanar, for the same one of the terminals, a distance between one of the two soldering legs and a central line of the neck portion and a distance between the other of the two soldering legs and the central line of the neck portion are not equal to each other, a strip connecting portion is protrudingly provided on a lower end of the positioning plate, the strip connecting portion is located between the two soldering legs, and the central line of the neck portion passes downward through the strip connecting portion.

16. The electrical connector assembly according to claim 11, wherein the at least one first contact pad is integrally connected to a first conductive layer, the at least one second contact pad is integrally connected to a second conductive layer, the mating component further has a plurality of mounting through holes running through a thickness direction thereof, two of the mounting through holes run through the first conductive layers of the two surfaces of the mating component, two others of the mounting through holes run through the second conductive layers of the two surfaces of the mating component, the mating component further comprises two positive cables and two negative cables, the two positive cables are connected to the first conductive layers, and the two negative cables are connected to the second conductive layers.
